(19) United States
(12) Patent Application Publication
(10) Pub. No.: US 2025/0301452 A1
(43) Pub. Date: Sep. 25, 2025

(54) BEAM DEVOTED FOR ALIGNMENT INITIATION BEFORE P1

(71) Applicant: QUALCOMM Incorporated, San Diego, CA (US)

(72) Inventors: Idan Michael HORN, Hod Hasharon (IL); Assaf TOUBOUL, Netanya (IL); Shay LANDIS, Hod Hasharon (IL)

(21) Appl. No.: 18/869,247

(22) PCT Filed: Jul. 20, 2023
(86) PCT No.: PCT/US2023/028265

§ 371 Date: Nov. 25, 2024

(30) Foreign Application Priority Data
Aug. 5, 2022 (IL) 295404

(51) Int. Cl. H04W 72/044; H04B 7/06

(52) U.S. Cl. CPC H04W 72/044; H04B 7/06968

(57) ABSTRACT

An apparatus that is one of a wireless device (or a network node) may be configured to receive (or transmit), via a first frequency range, a first synchronization signal block (SSB) indicating information regarding a second frequency range associated with a second SSB; receive (or transmit), via the second frequency range indicated by the first SSB, the second SSB, where the second frequency range includes frequencies in a higher frequency band than a lower frequency band comprising the first frequency range; and communicate with a transmitting (or receiving) device via a beam based on the second SSB.

### CROSS-REFERENCE TO RELATED APPLICATION

This application claims the benefit of Israel Patent Application Serial No. 295404, entitled “BEAM DEVOTED FOR ALIGNMENT INITIATION BEFORE P1” and filed on Aug. 5, 2022, which is expressly incorporated by reference herein in its entirety.

### TECHNICAL FIELD

The present disclosure relates generally to communication systems, and more particularly, to a beam management and/or beam training procedure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or user equipment (UE) configured to receive, via a first frequency range, a first SSB indicating information regarding a second frequency range associated with a second SSB; receive, via the second frequency range indicated by the first SSB, the second SSB, where the second frequency range includes frequencies in a higher frequency band than a lower frequency band comprising the first frequency range; and communicate with a transmitting device via a beam based on the second SSB.

In an aspect of the disclosure, a method, a computer-readable medium, and an apparatus are provided. The apparatus may be configured to transmit, via a first frequency range, a first SSB indicating information regarding a second frequency range associated with a second SSB; transmit, via the second frequency range indicated by the first SSB, the second SSB, where the second frequency range includes frequencies in a higher frequency band than a lower frequency band comprising the first frequency range; and communicate with a wireless device via a beam based on the second SSB.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram of a base station in communication with a UE in an access network.

FIG. 4 is a call flow diagram illustrating a two-step beam alignment using low-frequency and high-frequency signals.

FIG. 5 is a diagram illustrating a set of first transmission (Tx) beams for a first, lower frequency range and sets of second Tx beams associated with the first Tx beams for a second, higher frequency range.

FIG. 6 is a diagram illustrating a first SSB and a second SSB that may be transmitted via the first frequency range in the first set of reference signals and/or SSBs of FIG. 4 to indicate information regarding a corresponding third SSB in a second, higher frequency range.

FIG. 7 is a diagram illustrating a first set of SSBs in a first frequency range that indicate, by their placement in the first frequency range, information regarding corresponding SSBs in a second set of SSBs in the second frequency range.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

FIG. 13 is a diagram illustrating an example of a hardware implementation for a network entity.

### DETAILED DESCRIPTION

In some aspects of wireless communication, using high frequencies (e.g., sub-THz frequencies (110-160 GHz) and above) may introduce challenges in beam management. For example, signal attenuation (e.g., channel path loss) may lead to using a narrower beam for a beam management and/or beam training operation (e.g., a phase 1 (P1) operation) in order for a signal to arrive at a receiving device with sufficient power to detect the signal and distinguish the quality of a first beam (or channel) from a second beam (or channel). Using narrower beams, in some aspects, may be associated with a larger number of candidate beams that require a larger number of reference signal or SSB transmissions to sweep. Accordingly, in some aspects of the disclosure, a method or apparatus is provided to perform beam management (or beam training) using a first wider beam at a lower frequency associated with less signal attenuation (e.g., channel path loss).

For example, a transmitting device (e.g., a base station or UE) attempting to perform a beam training for communication via a second, higher frequency may transmit a first set of reference signals or SSBs via a corresponding first set of beams associated with a first, lower frequency range with a first half-power beam width (HPBW) that is relatively larger than a HPBW of a similarly beamformed beam associated with the second, higher frequency range. Based on a measured power of the reference signals or SSBs at a receiving device (e.g., a UE), the transmitting device may identify a corresponding second set of beams associated with the second, higher frequency range and transmit a second set of reference signals via the corresponding second set of beams associated with the second, higher frequency range. For example, the second set of beams, in some aspects, may include a set of beams at a highest (e.g., widest) level of a beam hierarchy used for a P1 beam training operation associated with the second, higher frequency range, where additional beam training (e.g., a second phase (P2) and subsequent phases) may be performed based on a beam at the highest level of the beam hierarchy that is identified as being associated with a best channel quality (e.g., a highest reference signal received power (RSRP), reference signal received quality (RSRQ), a reference signal received quality (RSRQ), a signal-to-noise ratio (SNR), a signal-to-interference-and-noise ratio (SINR) or other similar signal power and/or quality metric for reference signals received from a serving cell, base station beam(s), or UE beam(s)). In some aspects, the use of the first set of beams associated with the first, lower frequency range and the second set of beams associated with the second, higher frequency range may be conceived of as a two-step P1 operation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

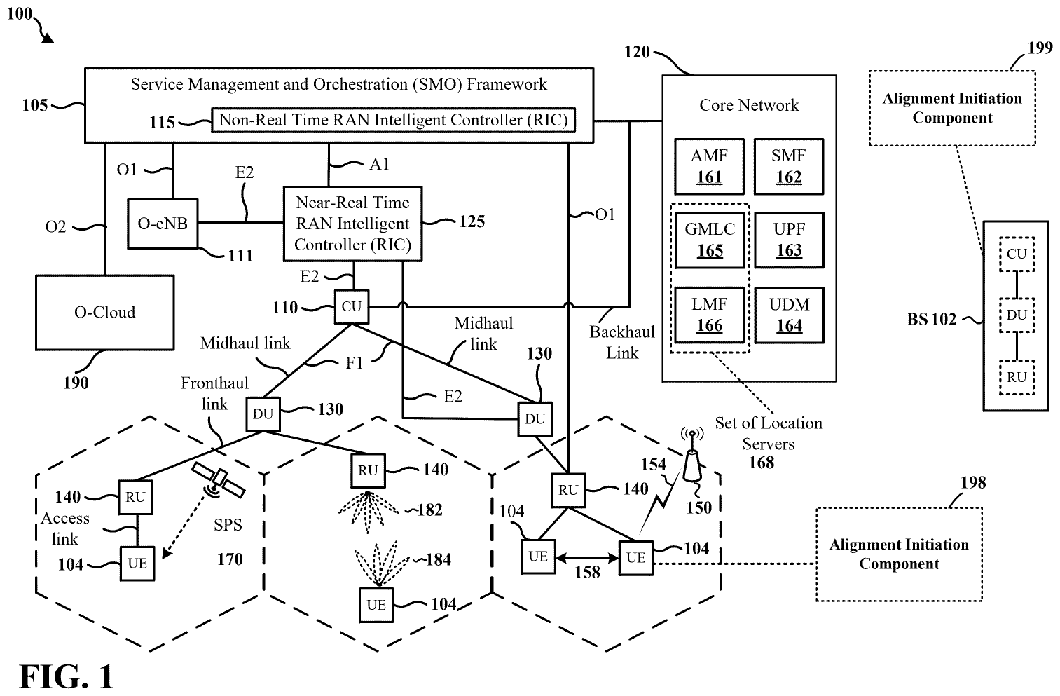

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an alignment initiation component 198 configured to receive, via a first frequency range, a first SSB indicating information regarding a second frequency range associated with a second SSB; receive, via the second frequency range indicated by the first SSB, the second SSB, where the second frequency range includes frequencies in a higher frequency band than a lower frequency band comprising the first frequency range; and communicate with a transmitting device via a beam based on the second SSB. In certain aspects, the base station 102 may include an alignment initiation component 199 configured to transmit, via a first frequency range, a first SSB indicating information regarding a second frequency range associated with a second SSB; transmit, via the second frequency range indicated by the first SSB, the second SSB, where the second frequency range includes frequencies in a higher frequency band than a lower frequency band comprising the first frequency range; and communicate with a wireless device via a beam based on the second SSB. Although the following description may be focused on 5G NR, the concepts described herein may be applicable to other similar areas, such as LTE, LTE-A, CDMA, GSM, and other wireless technologies.

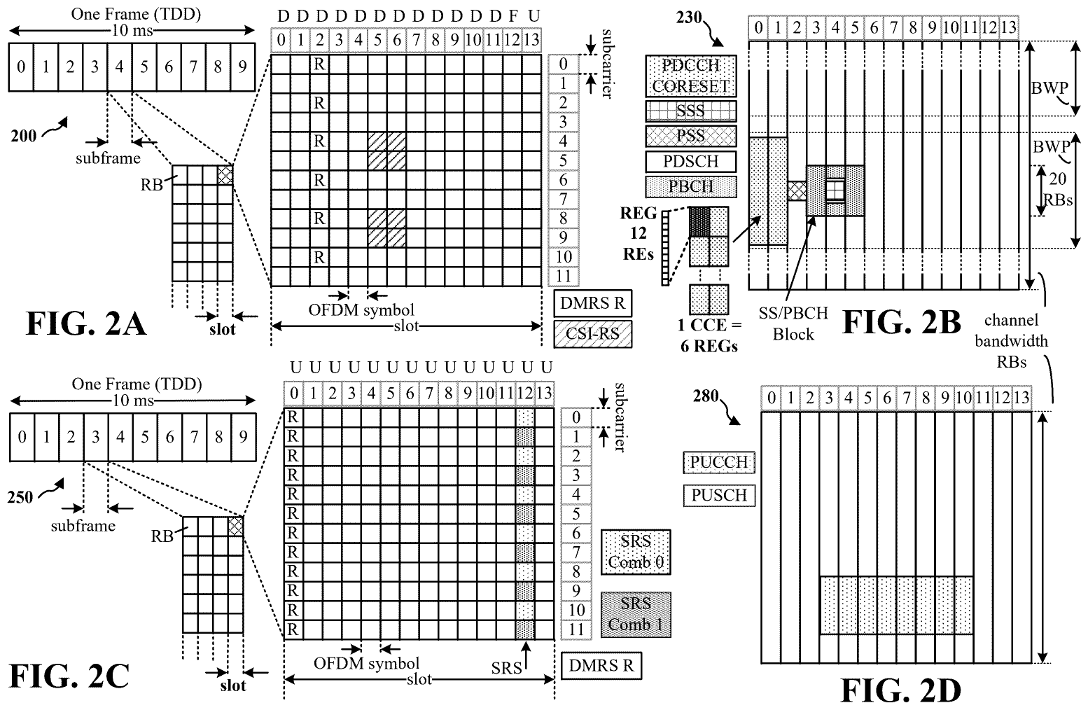

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

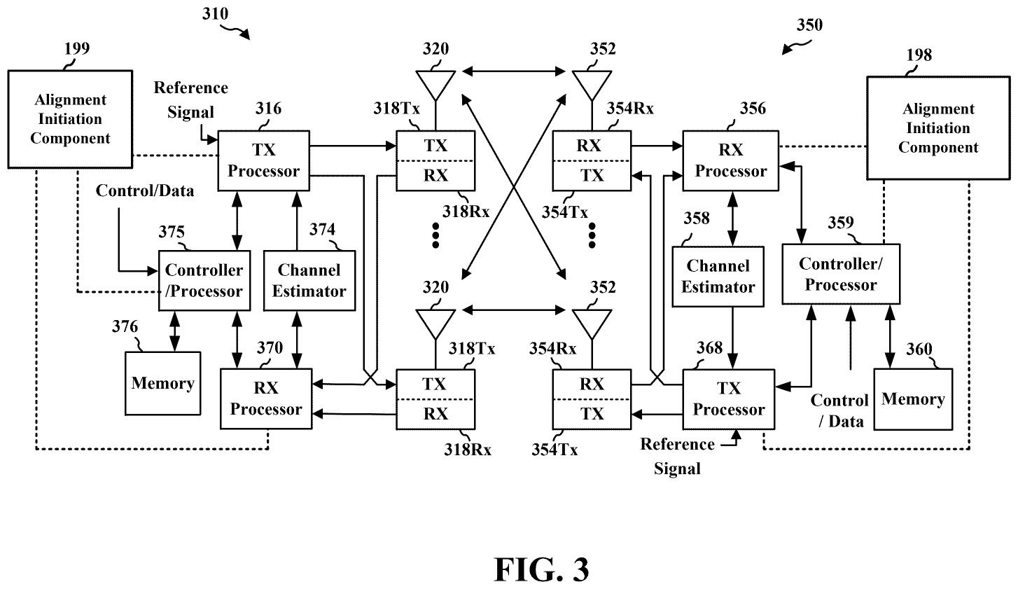

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the alignment initiation component 198 of FIG. 1.

At least one of the TX processor 316, the RX processor 370, and the controller/processor 375 may be configured to perform aspects in connection with the alignment initiation component 199 of FIG. 1.

In some aspects of wireless communication, using high frequencies (e.g., sub-THz frequencies (110-160 GHz), frequencies in FR4, or frequencies in FR5 and above) may introduce challenges in beam management. For example, signal attenuation (e.g., channel path loss) may lead to using a narrower beam for a beam management and/or beam training operation (e.g., a phase 1 (P1) operation) in order for a signal to arrive at a receiving device with sufficient power to detect the signal and distinguish the quality of a first beam (or channel) from a second beam (or channel). Using narrower beams, in some aspects, may be associated with a larger number of candidate beams that use a larger number of reference signal or SSB transmissions to sweep. Accordingly, in some aspects of the disclosure, a method or apparatus is provided to perform beam management (or beam training) using a first wider beam at a lower frequency associated with less signal attenuation (e.g., channel path loss) to reduce the time and/or resources used to sweep a full set of candidate beams.

For example, a transmitting device (e.g., a base station or UE) attempting to perform a beam training for communication via a second, higher frequency may transmit a first set of reference signals or SSBs via a corresponding first set of beams associated with a first, lower frequency range with a first HPBW that is relatively larger than a HPBW of a similarly beamformed beam associated with the second, higher frequency range. Based on a measured power of the reference signals or SSBs at a receiving device (e.g., a UE), the transmitting device may identify a corresponding second set of beams associated with the second, higher frequency range and transmit a second set of reference signals via the corresponding second set of beams associated with the second, higher frequency range. For example, the second set of beams, in some aspects, may include a set of beams at a highest (e.g., widest) level of a beam hierarchy used for a P1 beam training operation associated with the second, higher frequency range, where additional beam training (e.g., a second phase (P2) and subsequent phases) may be performed based on a beam at the highest level of the beam hierarchy that is identified as being associated with a best channel quality (e.g., a highest RSRP, RSRQ, SNR, SINR or other similar signal power and/or quality metric for reference signals received from a serving cell, base station beam(s), or UE beam(s)). In some aspects, the use of the first set of beams associated with the first, lower frequency range and the second set of beams associated with the second, higher frequency range may be conceived of as a two-step P1 operation.

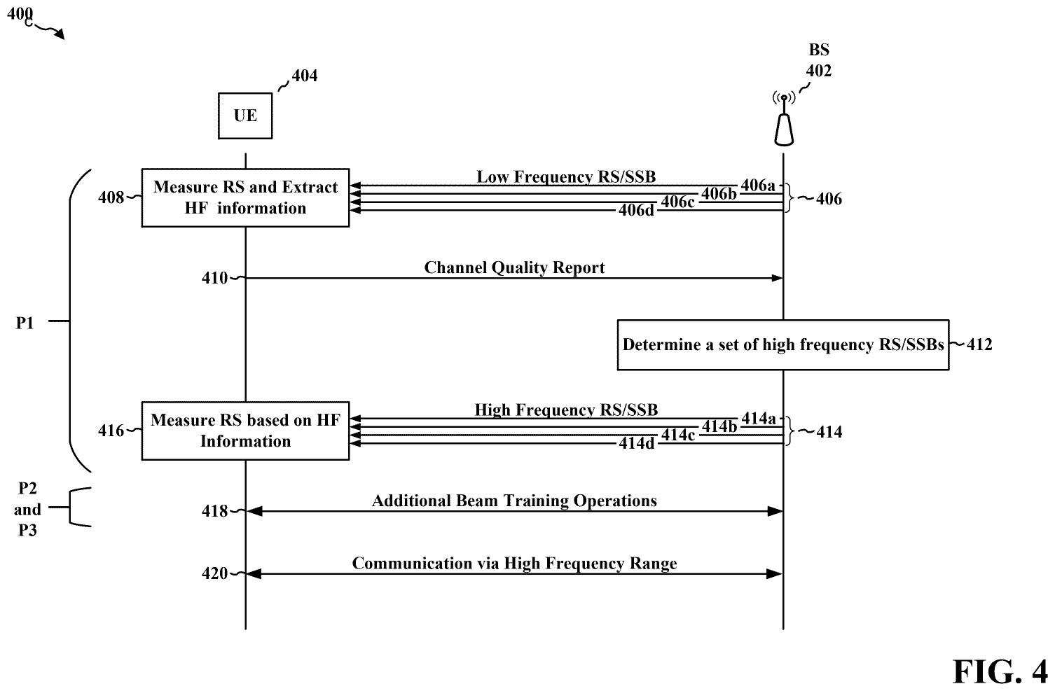

FIG. 4 is a call flow diagram 400 illustrating a two-step beam alignment using low-frequency and high-frequency signals. A beam training (or management) operation may be initiated (not illustrated) for communication between base station 402 (as an example of a network node or network entity) and a UE 404 (as an example of a wireless device) via a second (high) frequency range (e.g., sub-THz frequencies (110-160 GHz), frequencies in FR4, or frequencies in FR5 and above). Although the example in FIG. 4 is shown for a base station and a UE in order to illustrate the concept, the concept may be applied for any transmitter and receiver. For example, the beam training operation may be between an IAB node and a UE, between a parent IAB node and a child IAB node, between a UE and a UE, etc. The base station 402 may transmit a first set of reference signals and/or SSBs 406 in a first frequency range. The first set of reference signals and/or SSBs 406 may include a first RS or SSB 406a, a second RS or SSB 406b, a third RS or SSB 406c, and a fourth RS or SSB 406d (among other RS or SSBs) associated with particular transmission beam directions from the base station 402. The reference signal or SSB in the first set of reference signals and/or SSBs 406 may be an example of a discovery signal and/or other synchronization signal that may be used in some aspects. The first frequency range, in some aspects, may be a frequency range (e.g., FR1 (410 MHz-7.125 GHz)) that includes frequencies that are at least a factor of 2 less than frequencies in the second frequency range (e.g., FR2 (24.25 GHz-52.6 GHz)). The first set of reference signals and/or SSBs 406, in some aspects, may include a minimal payload, e.g., a cell ID and a higher-frequency indication.

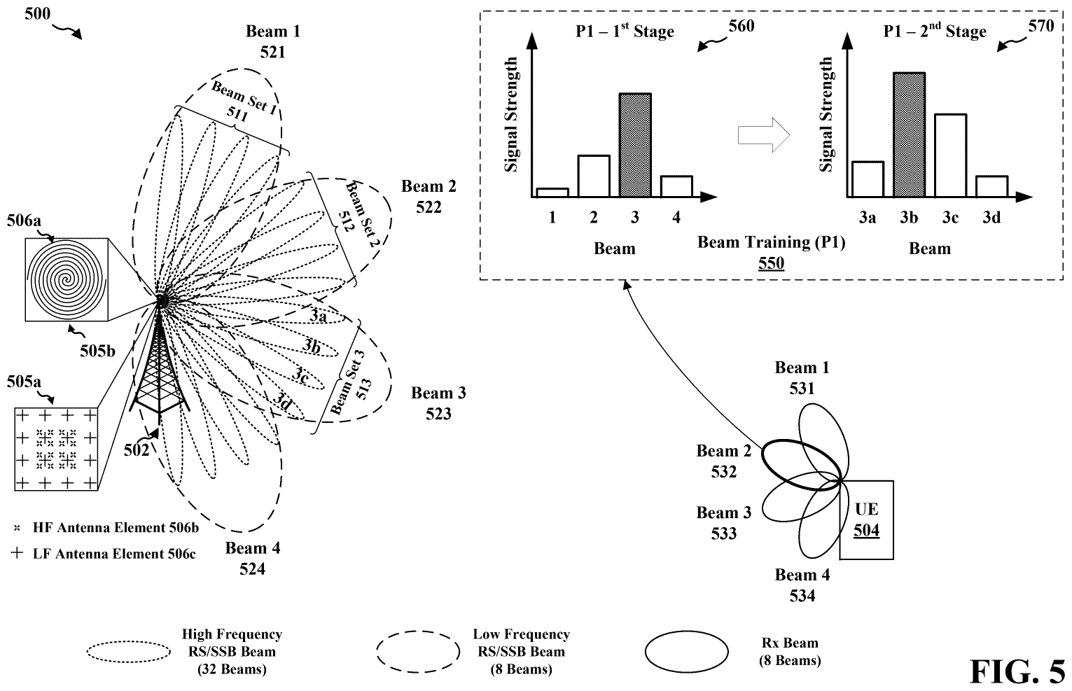

FIG. 5 is a diagram 500 illustrating a set of first transmission (Tx) beams for a first, lower frequency range and sets of second Tx beams associated with the first Tx beams for a second, higher frequency range. The set of first Tx beams may include beam 1 521, beam 2 522, beam 3 523, and beam 4 524 (in addition to similar beams mirroring the illustrated beams to complete a full 360° coverage). Each of the first Tx beams 521-524 may be associated with a set of second Tx beams, e.g., beam set 1 511, beam set 2 512, or beams set 3 513 for the second, higher frequency range. Accordingly, the first set of reference signals and/or SSBs 406 may, in some aspects, correspond to the set of first Tx beams 521-524.

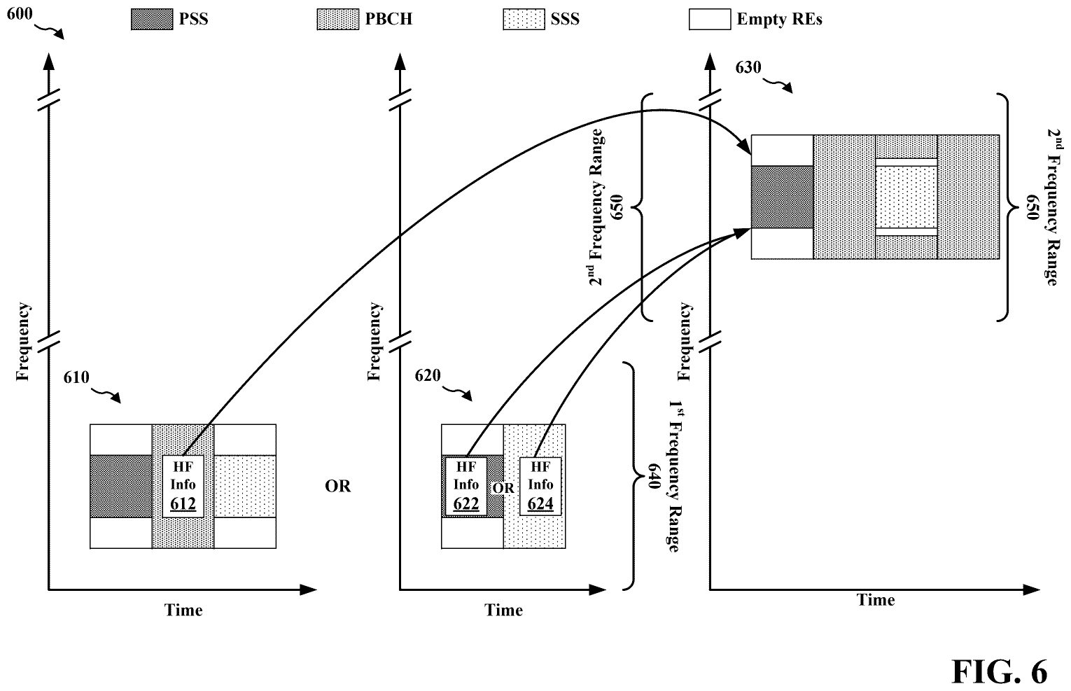

FIG. 6 is a set of diagrams 600, 610, 620, and 630 illustrating a first SSB and a second SSB that may be transmitted via the first frequency range 640 in the first set of reference signals and/or SSBs 406 of FIG. 4 to indicate information regarding a corresponding third SSB in a second, higher frequency range 650. For example, the high-frequency information 612 may, in some aspects, be carried transmitted as a dedicated MIB (e.g., in PBCH) including (1) pilots for equalization and (2) a frequency indication indicating the second, higher frequency that is associated with a corresponding higher frequency SSB (e.g., the third SSB illustrated in diagram 630) for beam training associated with the second, higher frequency. In some aspects, the frequency indication of the second, higher frequency may be encoded with Viterbi or polar encoding. Additional MIB parameters, in some aspects, may be omitted from the high-frequency information 612 as the additional MIB parameters may change in the higher frequency SSB.

In some aspects, the high-frequency information 622 or the high-frequency information 624 may, in some aspects, be transmitted as a set of bits in the PSS or the SSS, respectively. For example, a sequence may be transmitted in the PSS or SSS (e.g., high-frequency information 622 or 624, respectively) such that the first bits indicate the cell ID and the least significant bits (LSBs) indicate the second, higher frequency that is associated with a corresponding higher frequency SSB (e.g., the third SSB illustrated in diagram 630) for beam training associated with the second, higher frequency.

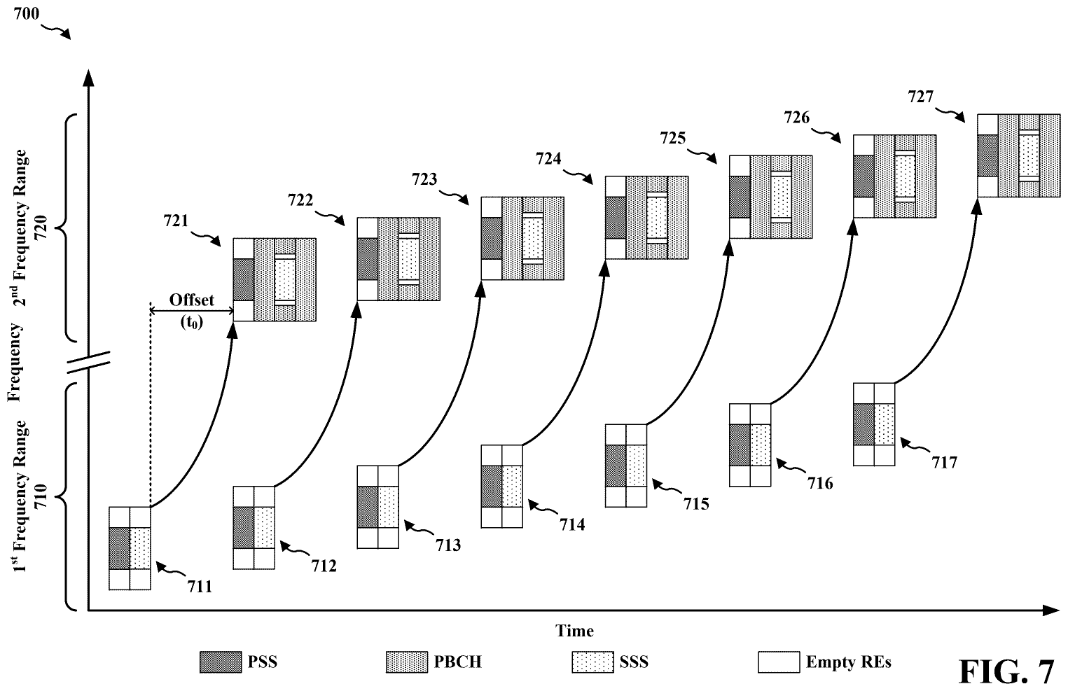

FIG. 7 is a diagram 700 illustrating a first set of SSBs (e.g., SSB 711, SSB 712, SSB 713, SSB 714, SSB 715, SSB 716, and SSB 717) in a first frequency range 710 that indicate, by their placement in the first frequency range, information regarding corresponding SSBs in a second set of SSBs (e.g., SSB 721, SSB 722, SSB 723, SSB 724, SSB 725, SSB 726, and SSB 727) in the second frequency range 720. While diagram 700 illustrates that SSBs 711-716 in the first set of SSBs at a lower frequency in the first frequency range 710 correspond to SSBs 721-726 in the second set of SSBs at a lower frequency in the second frequency range, the mapping may be distributed differently in some aspects. For example, SSBs at lower frequencies in the first frequency range may correspond to SSBs at higher frequencies in the second frequency range or there may be an arbitrary (configured or known) correspondence between SSBs in the first set of SSBs and the second set of SSBs. The first frequency range 710 and the second frequency range 720, in some aspects, include multiple frequency bands in which the individual SSBs 711-717 and 721-727, respectively, that may be disjoint (not illustrated).

As described in relation to diagrams 610 and 620, the SSBs 711-717 may include additional information regarding the corresponding SSB 721-727, respectively, in the second set of SSBs. The additional information, in some aspects, may include quasi-co-location (QCL) information relating the SSB in the first frequency range with the SSB in the second frequency range. In some aspects, the SSB (e.g., SSB 711 or the SSBs illustrated in diagrams 610 and 620) may include information regarding a timing of the corresponding SSB (e.g., SSB 721 or the SSB illustrated in diagram 630) in the second frequency range. For example, an SSB may include an offset “to” between a time associated with the SSB in the first frequency range (e.g., the end of the last symbol of the SSB in the first frequency range) and a time associated with the SSB (e.g., the beginning of the first symbol of the SSB in the second frequency range). In some aspects, the time offset may be known (e.g., pre-configured, or configured via RRC or a MAC-CE).

In some aspects, any of the SSBs in the first frequency range illustrated in diagrams 610, 620, or 700 may include additional information regarding a beam index a single frequency network (SFN), or other information used to compensate for an ability to transmit RACH for the low frequency range. The numerology of the SSBs in the first frequency range, in some aspects, may be the same as the numerology of the SSBs in the second frequency range. Alternatively, the SSBs in the first frequency range may be associated with a lower numerology than the numerology associated with the SSBs in the second frequency range.

At 408, the UE 404 may measure the first set of reference signals and/or SSBs 406 and extract information regarding a second set of reference signals and/or SSBs at a second, higher frequency. For example, the UE 404 may determine that a particular RS or SSB in the first set of reference signals and/or SSBs 406 associated with a particular beam has a highest signal strength and use information extracted from the particular RS or SSB to determine parameters for a beam training operation associated with the second frequency range. For example, referring to FIG. 5, the UE 504 may measure the signal strength associated with each of the first Tx beams 521-524 for each of a set of third receive (Rx) beams including Rx beam 1 531, Rx beam 2 532, Rx beam 3 533, and Rx beam 4 534. Graph 560 illustrates an example signal strength measurement for the set of beams 521-524 measured via Rx beam 2 532. Based on the measurements associated with graph 560, the UE 504 may determine to use (or extract) information regarding a second set of reference signals and/or SSBs at a second, higher frequency included in the RS and/or SSB associated with beam 3 523.

The UE 404 may also transmit, and base station 402 may receive, a channel quality report indicating a beam associated with one of the first set of reference signals and/or SSBs 406 with a greatest signal quality and/or strength (e.g., a greatest RSRP, RSRQ, SNR, SINR, or other measure of channel quality and/or strength). For example, referring to FIG. 5, the UE 504 may, based on the measurements illustrated in graph 560, transmit a report or other indication (corresponding to channel quality report 410) indicating that beam 3 is associated with a strongest signal. The indication may be based on a RACH or other connection-related transmission from the UE 504 via a beam associated with the strongest signal from the base station 502 to initiate communication with the base station 502. In some aspects, the channel quality report may include a measured signal strength and/or quality for each beam associated with one of the first set of reference signals and/or SSBs 406 or may include an indication of a beam associated with a greatest signal strength and/or quality not including the measured signal strength and/or quality.

Based on the channel quality report 410, the base station 402 may determine, at 412, a second set of high-frequency reference signals and/or SSBs (e.g., a set of RS and/or SSBs associated with a second set of narrower beams in the second frequency range) at the second, higher frequency range corresponding to the beam associated with the strongest signal strength. For example, referring to FIG. 5, the base station 502 may, based on a report regarding the measurements indicated in graph 560, determine that the set of second Tx beams, beam set 3 513, is indicated to be used for a second stage of a first phase (illustrated in graph 570) of the beam training operation 550 for the higher frequency range. The UE 404 and/or the UE 504 may use a known mapping or QCL to identify the set of second Tx beam from the channel quality report 410 (or other indication or report implemented to provide feedback regarding the lower frequency RSs/SSBs/beams).

The base station 402 may transmit, and the UE 404 may receive, a second set of reference signals and/or SSBs 414 associated with the second frequency range identified based on the measurements of the first set of reference signals and/or SSBs 406. The second set of reference signals and/or SSBs 414 may include a first RS or SSB 414a, a second RS or SSB 414b, a third RS or SSB 414c, and a fourth RS or SSB 414d. The second set of reference signals and/or SSBs 414, in some aspects, may include a reduced payload based on omitting information included in the first set of reference signals and/or SSBs 406.

For example, referring to FIG. 5, the base station 502, after determining that the set of second Tx beams, beam set 3 513, is indicated to be used for a second stage of a first phase (illustrated in graph 570) of the beam training operation 550, may transmit RSs and/or SSBs to the UE 504 via each of beam 3a, beam 3b, beam 3c, and beam 3d. In some aspects, the base station 502 may include one or more antennas and/or lenses. For example, the base station 502 may include a multi-frequency antenna 505a employing a spiral antenna 506a. In some aspects, the base station 502 may include an antenna, or set of antennas, 505b including interleaved arrays of high frequency antenna elements 506b and low frequency antenna elements 506c with a same array center. The base station 502, in some aspects, may include a dish\lens antenna with two different frequency feed antennas where the lens is responsible for analog beamforming and using the same lens for both frequencies may create two different beams with different beam width.

The UE 404 may, at 416, measure the second set of reference signals and/or SSBs 414 based on the measurement(s) made of, and the information extracted from, the first set of reference signals and/or SSBs 406 at 408. For example, referring to FIG. 5, the UE 504 may measure a set of RSs and/or SSBs transmitted via the beams in beam set 3 513 as indicated in graph 570 based on information included in the RS and/or SSB transmitted via beam 3 523 associated with the first frequency range.

After the base station 402 transmits, and UE 404 measures (at 416), the second set of reference signals and/or SSBs 414, the base station 402 and UE 404 may exchange additional RSs and/or SSBs as part of additional beam training operations 418. For example, the reception and measurement at 408 and 416 may be part of a P1 process, as shown in FIG. 4. The additional beam training operations 418 may include beam refinement operations based on a beam identified via the (multi-frequency) two-step P1 process discussed above to identify a beam for communication between the base station 402 and the UE 404. For example, as part of beam management, a P1 process may be referred to as a beam selection, and the other processes, e.g., a P2 and/or P3 process, may be referred to as beam refinement, e.g., based on the beam selection. The additional beam training operations at 418 may correspond to a P2 and/or P3 process. As an example, for the beam selection in P1, the base station may sweep (e.g., transmit a signal over) a set of beams and the UE may select a best beam and report it to the base station. In P2, the base station may sweep a set of narrower, refined beams over a narrower range, and the UE may detect the best beam among the narrower beams and report it to the base station. The P2 process may refine the transmission beam (e.g., enable a selection of a narrower beam) for the transmitter, e.g., the base station. In P3, the base station may use a fixed beam for transmitting a signal, and the UE may refine its receiver beam by measuring the signal over a set of receiver beams and selecting a receiver beam to use for communication with the base station. The P3 process may be referred to as beam refinement for a receiver. Although the P1, P2, P3 example is described for a base station and a UE, the process may be performed for any transmitter and receiver. Once the beam for communication has been identified and/or determined, the base station 402 and the UE 404 may engage in communication 420 via the high frequency range associated with the second set of reference signals and/or SSBs 414.

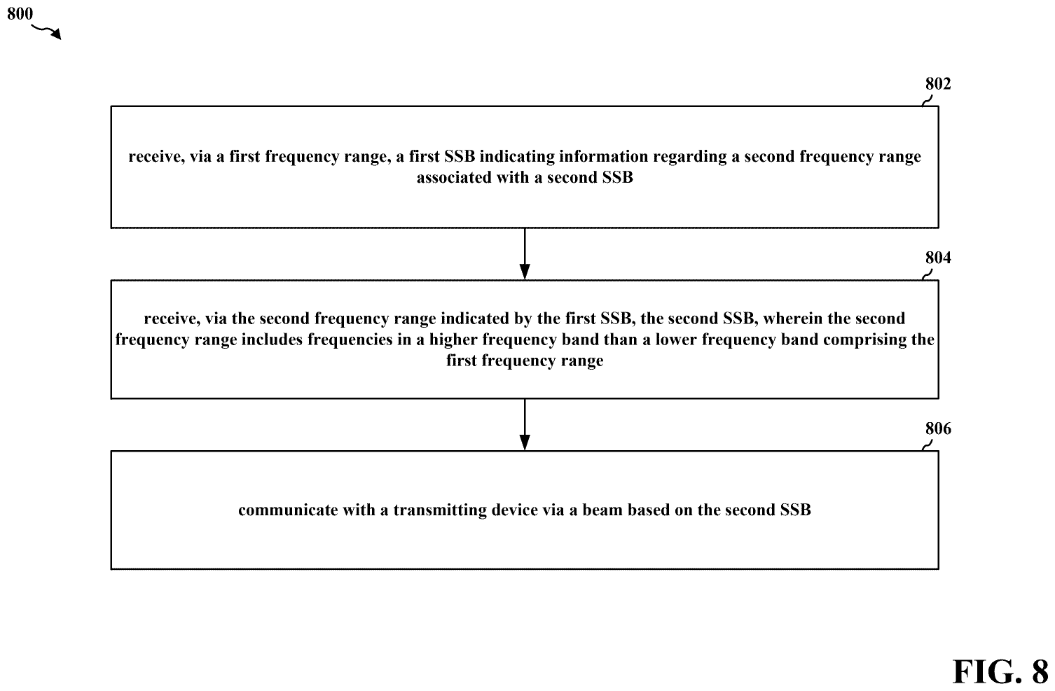

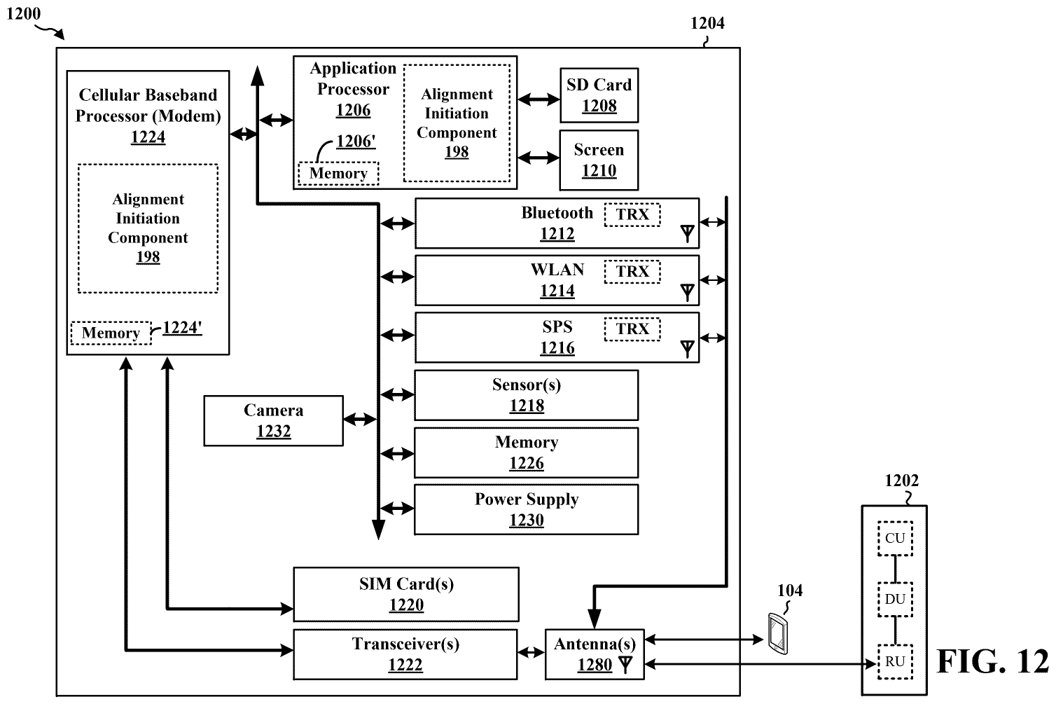

FIG. 8 is a flowchart 800 of a method of wireless communication. The method may be performed by a wireless device (e.g., the UE 104, 404, 504; the apparatus 1204). The method may be performed by any receiver and is not limited to a UE. At 802, the wireless device may receive, via a first frequency range, a first SSB indicating information regarding a second frequency range associated with a second SSB. For example, 802 may be performed by application processor 1206, cellular baseband processor 1224, transceiver(s) 1222, antenna(s) 1280, and/or alignment initiation component 198 of FIG. 12. In some aspects, the first SSB may include a cell ID. The cell ID, in some aspects, may be included in a first set of bits in a PSS or a SSS. The PSS or the SSS, in some aspects, may further include the information regarding the second frequency range in a second set of bits. The information regarding the second frequency range, in some aspects, includes QCL information. The QCL information, in some aspects, may indicate a QCL between the first SSB and the second SSB. The first SSB, in some aspects, may indicate timing for a transmission of the second SSB. The timing for the transmission of the second SSB may be indicated based on a time occasion of the transmission of the first SSB and an offset value that is zero or greater than zero. For example, referring to FIGS. 4-7, the UE 404/504 may receive the first set of reference signals and/or SSBs 406 (e.g., via beams 1-4 521-524) including the high-frequency information 612, 622, or 624 (e.g., information regarding the second frequency range), or indicating, by their placement in the first frequency range, information regarding corresponding SSBs in a second set of SSBs (e.g., SSB 721, SSB 722, SSB 723, SSB 724, SSB 725, SSB 726, and SSB 727) in the second frequency range 720. In aspects with co-located high-frequency and low-frequency antennas (e.g., antennas 505a and/or 505b having high-frequency and low-frequency components with a shared center), the QCL information may be based on knowledge of the co-location of the antennas for the different frequency ranges. Additionally, the timing information may be indicated based on the timing of the SSB in the first frequency range 710 timing offset t₀.

In some aspects, the information regarding the second frequency range is included in a PBCH of the first SSB. For example, in some aspects, the information regarding the second frequency range is included in a first MIB in the first SSB. The first MIB, in some aspects, may include pilots for equalization and the information regarding the second frequency range and the information regarding the second frequency range may be encoded in the first MIB with one of Viterbi encoding or polar encoding. For example, referring to FIG. 6, the SSB illustrated in diagram 610 may include high-frequency information 612 in a MIB in a PBCH.

In some aspects, the information regarding the second frequency range is indicated by a known mapping between the first frequency range and the second frequency range. For example, referring to FIG. 7, the placement of an SSB (e.g., SSB 711-717) in the first frequency range 710 may indicate, based on a known mapping, information (e.g., a frequency range and timing) associated with an SSB (e.g., SSB 721-727) in the second frequency range 720.

The wireless device (e.g., UE 404 or 504) may receive the transmitted, first SSB among a set of SSBs transmitted via the first frequency range and measure a signal strength and/or quality of each SSB in the set of SSBs to determine that the first SSB has a highest strength and/or quality. The wireless device may, based on the determination, extract the information regarding the second frequency range associated with a second SSB from the first SSB. The wireless device may transmit, to the network node, a report or other indication that the first SSB is associated with a highest signal strength and/or quality. For example, referring to FIGS. 4 and 5, the UE 404 or 504 may transmit, and the base station 402 or 502 may receive, channel quality report 410 (or other indication) indicating that a particular beam (e.g., beam 3 523) has a highest signal strength and/or quality.

At 804, the wireless device may receive, via the second frequency range indicated by the first SSB, the second SSB. In some aspects, the second frequency range includes frequencies in a higher frequency band than a lower frequency band including the first frequency range. For example, 804 may be performed application processor 1206, cellular baseband processor 1224, transceiver(s) 1222, antenna(s) 1280, and/or alignment initiation component 198 of FIG. 12. In some aspects, the first SSB may be received at 802 from a first antenna and the second SSB may be received at 804 via a second antenna. The first SSB and the second SSB, in some aspects may be received at 802 and 804, respectively, by a same antenna. For example, referring to FIGS. 4-7, the UE 404 or 504 may receive the second set of reference signals and/or SSBs 414 (e.g., the SSB illustrated in diagram 630 in the second frequency range 650 or one of the SSB 721-727 in the second frequency range 720) via a set of beams (e.g., beams 3a-3d in beam set 3 513).

The transmission of the second SSB, at 804, may be a first phase (e.g., P1) of a beam training operation associated with the second frequency range. Additional operations associated with the beam training (e.g., beam refining) may be performed by the wireless device and the network node to determine one or more beams used for a communication between the wireless device and the network node. For example, referring to FIG. 4, the base station 402 and the UE 404 may exchange additional RSs and/or SSBs as part of additional beam training operations 418.

Finally, at 806, the wireless device may communicate with the network node via a beam based on the second SSB. For example, 804 may be performed by application processor 1206, cellular baseband processor 1224, transceiver(s) 1222, and/or antenna(s) 1280, of FIG. 12. The communication, in some aspects, may be via the second frequency range. For example, referring to FIG. 4, the base station 402 and the UE 404 may engage in communication 420 via the high frequency range associated with the second set of reference signals and/or SSBs 414.

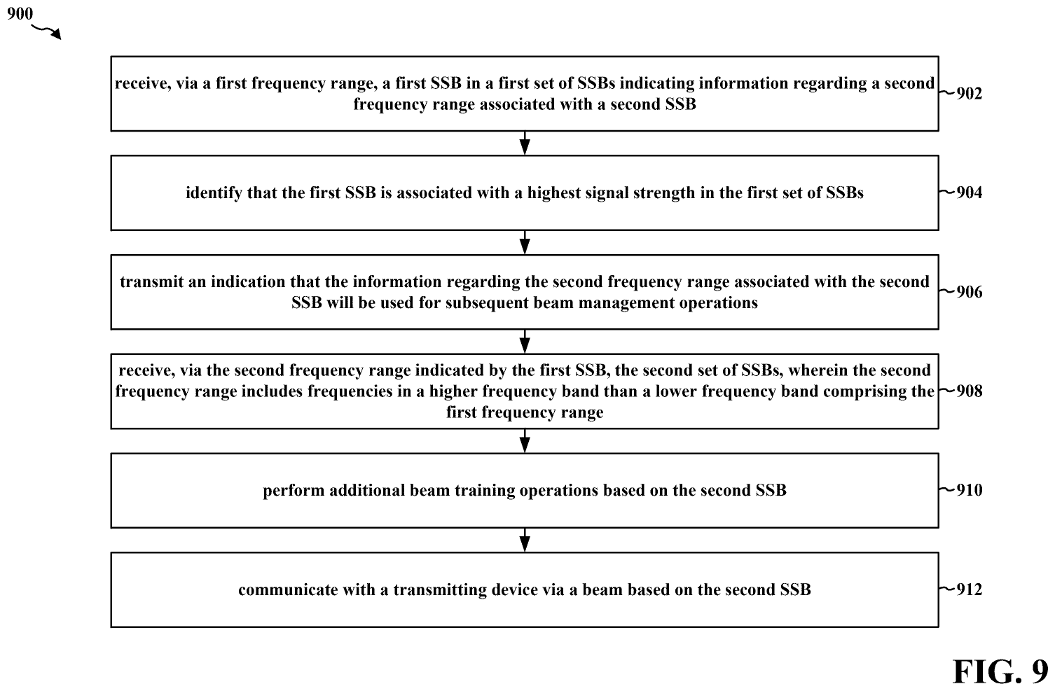

FIG. 9 is a flowchart 900 of a method of wireless communication. The method may be performed by a wireless device (e.g., the UE 104, 404, 504; the apparatus 1204). The method may be performed by any receiver and is not limited to a UE. At 902, the wireless device may receive, via a first frequency range, a first SSB indicating information regarding a second frequency range associated with a second SSB. For example, 902 may be performed by application processor 1206, cellular baseband processor 1224, transceiver(s) 1222, antenna(s) 1280, and/or alignment initiation component 198 of FIG. 12. In some aspects, the first SSB may include a cell ID. The cell ID, in some aspects, may be included in a first set of bits in a PSS or a SSS. The PSS or the SSS, in some aspects, may further include the information regarding the second frequency range in a second set of bits. The information regarding the second frequency range, in some aspects, includes QCL information. The QCL information, in some aspects, may indicate a QCL between the first SSB and the second SSB. The first SSB, in some aspects, may indicate timing for a transmission of the second SSB. The timing for the transmission of the second SSB may be indicated based on a time occasion of the transmission of the first SSB and an offset value that is zero or greater than zero. For example, referring to FIGS. 4-7, the UE 404/504 may receive the first set of reference signals and/or SSBs 406 (e.g., via beams 1-4 521-524) including the high-frequency information 612, 622, or 624 (e.g., information regarding the second frequency range), or indicating, by their placement in the first frequency range, information regarding corresponding SSBs in a second set of SSBs (e.g., SSB 721, SSB 722, SSB 723, SSB 724, SSB 725, SSB 726, and SSB 727) in the second frequency range 720. In aspects with co-located high-frequency and low-frequency antennas (e.g., antennas 505a and/or 505b having high-frequency and low-frequency components with a shared center), the QCL information may be based on knowledge of the co-location of the antennas for the different frequency ranges. Additionally, the timing information may be indicated based on the timing of the SSB in the first frequency range 710 timing offset t₀.

In some aspects, the information regarding the second frequency range is included in a PBCH of the first SSB. For example, in some aspects, the information regarding the second frequency range is included in a first MIB in the first SSB. The first MIB, in some aspects, may include pilots for equalization and the information regarding the second frequency range and the information regarding the second frequency range may be encoded in the first MIB with one of Viterbi encoding or polar encoding. For example, referring to FIG. 6, the SSB illustrated in diagram 610 may include high-frequency information 612 in a MIB in a PBCH.

In some aspects, the information regarding the second frequency range is indicated by a known mapping between the first frequency range and the second frequency range. For example, referring to FIG. 7, the placement of an SSB (e.g., SSB 711-717) in the first frequency range 710 may indicate, based on a known mapping, information (e.g., a frequency range and timing) associated with an SSB (e.g., SSB 721-727) in the second frequency range 720.

The wireless device (e.g., UE 404 or 504) may receive the transmitted, first SSB among a set of SSBs transmitted via the first frequency range and measure a signal strength and/or quality of each SSB in the set of SSBs to determine that the first SSB has a highest strength and/or quality. The wireless device may, based on the determination, extract the information regarding the second frequency range associated with a second SSB from the first SSB. The wireless device may transmit, to the network node, a report or other indication that the first SSB is associated with a highest signal strength and/or quality. For example, referring to FIGS. 4 and 5, the UE 404 or 504 may transmit, and the base station 402 or 502 may receive, channel quality report 410 (or other indication) indicating that a particular beam (e.g., beam 3 523) has a highest signal strength and/or quality.

At 904, the wireless device may identify that the first SSB is associated with a highest signal strength in the first set of SSBs. In order to identify, at 904, that the first SSB has a highest strength and/or quality, the wireless device may measure a signal strength and/or quality of each SSB in the set of SSBs. For example, 904 may be performed by application processor 1206, cellular baseband processor 1224, and/or alignment initiation component 198 of FIG. 12. The wireless device may, based on the determination, extract the information regarding the second frequency range associated with a second SSB from the first SSB. For example, referring to FIGS. 4 and 5, the UE 404 or 504 may, at 408, measure the first set of reference signals and/or SSBs 406 (via beams 1-4 521-524) and identify that a particular SSB (e.g., the SSB associated with beam 3 523) is associated with a highest signal strength in the first set of reference signals and/or SSBs 406. The UE 404 or 504 may also, at 408, extract information regarding a second set of reference signals and/or SSBs (e.g., associated with beam set 3 513) at a second, higher frequency.

The wireless device may, at 906, transmit an indication that the information regarding the second frequency range associated with the second SSB will be used for subsequent beam management operations. For example, 906 may be performed by application processor 1206, cellular baseband processor 1224, transceiver(s) 1222, antenna(s) 1280, and/or alignment initiation component 198 of FIG. 12. The indication may include a report or other indication that the first SSB is associated with a highest signal strength and/or quality. For example, referring to FIGS. 4 and 5, the UE 404 or 504 may transmit, and the base station 402 or 502 may receive, channel quality report 410 (or other indication) indicating that a particular beam (e.g., beam 3 523) has a highest signal strength and/or quality.

At 908, the wireless device may receive, via the second frequency range indicated by the first SSB, the second SSB. In some aspects, the second frequency range includes frequencies in a higher frequency band than a lower frequency band including the first frequency range. For example, 904 may be performed application processor 1206, cellular baseband processor 1224, transceiver(s) 1222, antenna(s) 1280, and/or alignment initiation component 198 of FIG. 12. In some aspects, the first SSB may be received at 902 from a first antenna and the second SSB may be received at 904 via a second antenna. The first SSB and the second SSB, in some aspects may be received at 902 and 904, respectively, by a same antenna. For example, referring to FIGS. 4-7, the UE 404 or 504 may receive the second set of reference signals and/or SSBs 414 (e.g., the SSB illustrated in diagram 630 in the second frequency range 650 or one of the SSB 721-727 in the second frequency range 720) via a set of beams (e.g., beams 3a-3d in beam set 3 513).

The reception of the second SSB, at 908, may be a first phase (e.g., P1) of a beam training operation associated with the second frequency range. may be a first phase (e.g., P1) of a beam training operation associated with the second frequency range. The wireless device may, at 910, perform additional beam training (e.g., beam refining) operations based on the second SSB with the wireless device. For example, 910 may be performed by application processor 1206, cellular baseband processor 1224, transceiver(s) 1222, and/or antenna(s) 1280 of FIG. 12. The additional beam training operations may be performed at 910 for beam training may be performed to determine one or more beams used for a communication between the network node and the wireless device. For example, referring to FIG. 4, the UE 404 and the base station 402 may exchange additional RSs and/or SSBs as part of additional beam training operations 418.

Finally, at 912, the network node may communicate with the wireless device via a beam based on the second SSB. For example, 912 may be performed by application processor 1206, cellular baseband processor 1224, transceiver(s) 1222, and/or antenna(s) 1280 of FIG. 12. The communication, in some aspects, may be via the second frequency range. For example, referring to FIG. 4, the base station 402 and the UE 404 may engage in communication 420 via the high frequency range associated with the second set of reference signals and/or SSBs 414.

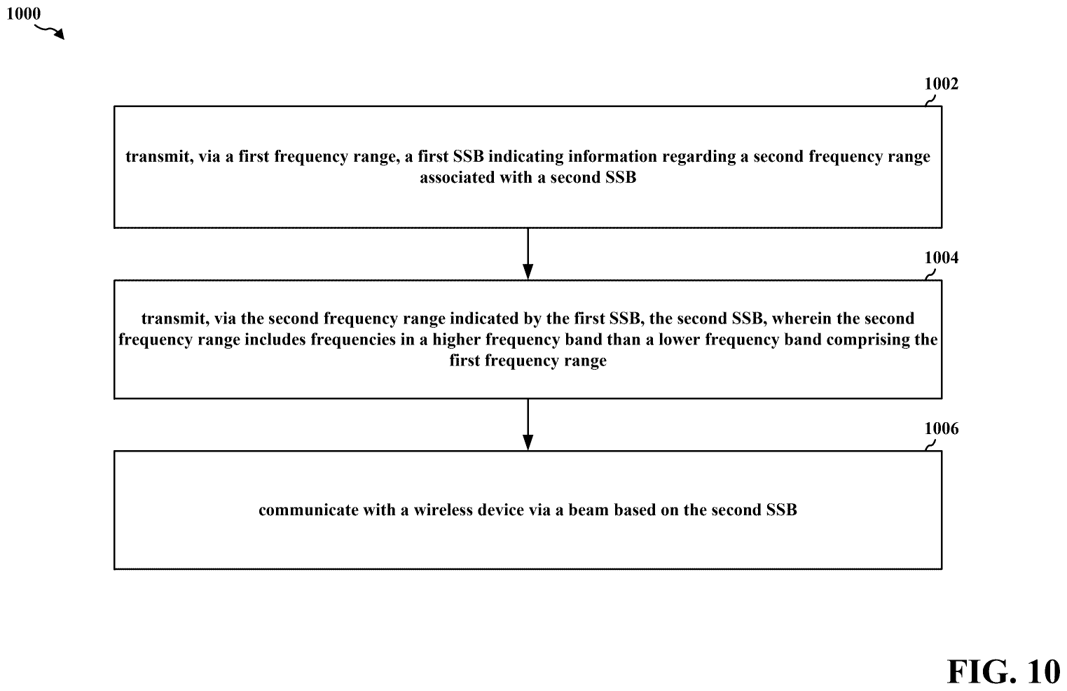

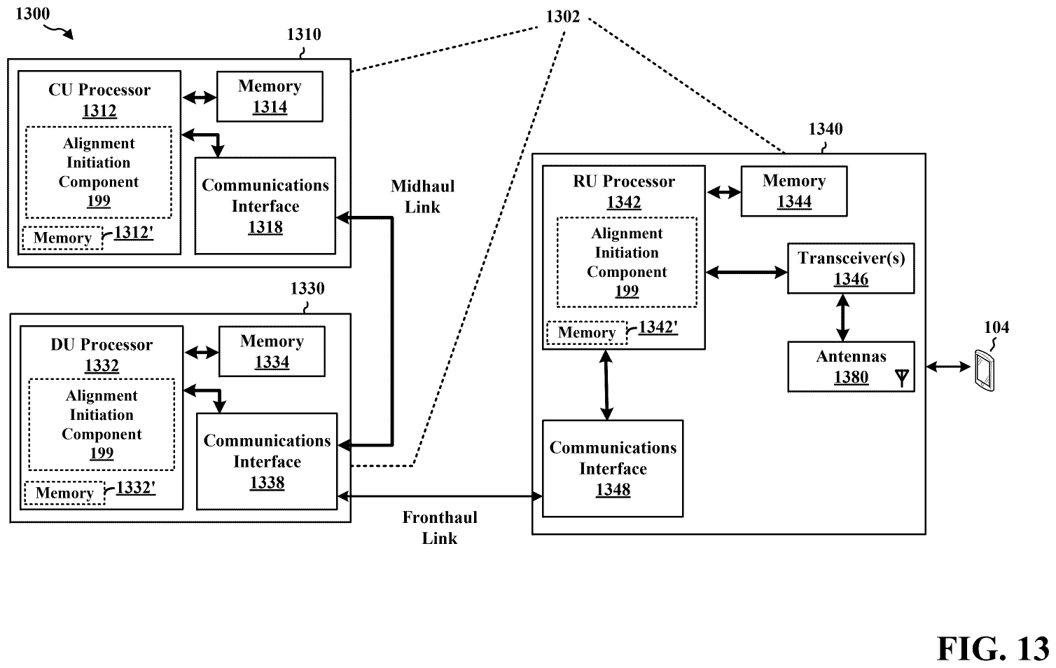

FIG. 10 is a flowchart 1000 of a method of wireless communication. The method may be performed by a network node (e.g., the base station 102, 402, or 502; the CU 110; the DU 130; the RU 140; the network entity 1302). In some aspects, the network node may be a base station or a component of a base station. In some aspects, the network node may be an IAB node or other network node. In some aspects, the method may be performed by a UE, e.g., for sidelink communication. At 1002, the network node may transmit, via a first frequency range, a first SSB indicating information regarding a second frequency range associated with a second SSB. For example, 1002 may be performed by CU processor 1312, DU processor 1332, RU processor 1342, transceiver(s) 1346, antenna(s) 1380, and/or alignment initiation component 199 of FIG. 13. In some aspects, the first SSB may include a cell ID. The cell ID, in some aspects, may be included in a first set of bits in a PSS or a SSS. The PSS or the SSS, in some aspects, may further include the information regarding the second frequency range in a second set of bits. The information regarding the second frequency range, in some aspects, includes QCL information. The QCL information, in some aspects, may indicate a QCL between the first SSB and the second SSB. The first SSB, in some aspects, may indicate timing for a transmission of the second SSB. The timing for the transmission of the second SSB may be indicated based on a time occasion of the transmission of the first SSB and an offset value that is zero or greater than zero. For example, referring to FIGS. 4-7, the base station 402/502 may transmit the first set of reference signals and/or SSBs 406 (e.g., via beams 1-4 521-524) including the high-frequency information 612, 622, or 624 (e.g., information regarding the second frequency range), or indicating, by their placement in the first frequency range, information regarding corresponding SSBs in a second set of SSBs (e.g., SSB 721, SSB 722, SSB 723, SSB 724, SSB 725, SSB 726, and SSB 727) in the second frequency range 720. In aspects with co-located high-frequency and low-frequency antennas (e.g., antennas 505a and/or 505b having high-frequency and low-frequency components with a shared center), the QCL information may be based on knowledge of the co-location of the antennas for the different frequency ranges. Additionally, the timing information may be indicated based on the timing of the SSB in the first frequency range 710 timing offset t₀.

In some aspects, the information regarding the second frequency range is included in a PBCH of the first SSB. For example, in some aspects, the information regarding the second frequency range is included in a first MIB in the first SSB. The first MIB, in some aspects, may include pilots for equalization and the information regarding the second frequency range and the information regarding the second frequency range may be encoded in the first MIB with one of Viterbi encoding or polar encoding. For example, referring to FIG. 6, the SSB illustrated in diagram 610 may include high-frequency information 612 in a MIB in a PBCH.

In some aspects, the information regarding the second frequency range is indicated by a known mapping between the first frequency range and the second frequency range. For example, referring to FIG. 7, the placement of an SSB (e.g., SSB 711-717) in the first frequency range 710 may indicate, based on a known mapping, information (e.g., a frequency range and timing) associated with an SSB (e.g., SSB 721-727) in the second frequency range 720.

A wireless device (e.g., UE 404 or 504) may receive the transmitted, first SSB among a set of SSBs transmitted via the first frequency range and measure a signal strength and/or quality of each SSB in the set of SSBs to determine that the first SSB has a highest strength and/or quality. The wireless device may, based on the determination, extract the information regarding the second frequency range associated with a second SSB from the first SSB. The network node may receive, from the wireless device, a report or other indication that the first SSB is associated with a highest signal strength and/or quality. For example, referring to FIGS. 4 and 5, the UE 404 or 504 may transmit, and the base station 402 or 502 may receive, channel quality report 410 (or other indication) indicating that a particular beam (e.g., beam 3 523) has a highest signal strength and/or quality.

At 1004, the network node may transmit, via the second frequency range indicated by the first SSB, the second SSB. In some aspects, the second frequency range includes frequencies in a higher frequency band than a lower frequency band including the first frequency range. For example, 1004 may be performed by CU processor 1312, DU processor 1332, RU processor 1342, transceiver(s) 1346, antenna(s) 1380, and/or alignment initiation component 199 of FIG. 13. In some aspects, the first SSB may be transmitted at 1002 via a first antenna and the second SSB may be transmitted at 1004 via a second antenna. The first SSB and the second SSB, in some aspects may be transmitted at 1002 and 1004, respectively, by a same antenna. For example, referring to FIGS. 4-7, the base station 402 or 502 may transmit the second set of reference signals and/or SSBs 414 (e.g., the SSB illustrated in diagram 630 in the second frequency range 650 or one of the SSB 721-727 in the second frequency range 720) via a set of beams (e.g., beams 3a-3d in beam set 3 513).

The transmission of the second SSB, at 1004, may be a first phase (e.g., P1) of a beam training operation associated with the second frequency range. Additional operations associated with the beam training (e.g., beam refining) may be performed by the network node and the wireless device to determine one or more beams used for a communication between the network node and the wireless device. For example, referring to FIG. 4, the base station 402 and the UE 404 may exchange additional RSs and/or SSBs as part of additional beam training operations 418.

Finally, at 1006, the network node may communicate with the wireless device via a beam based on the second SSB. For example, 1004 may be performed by CU processor 1312, DU processor 1332, RU processor 1342, transceiver(s) 1346, and/or antenna(s) 1380 of FIG. 13. The communication, in some aspects, may be via the second frequency range. For example, referring to FIG. 4, the base station 402 and the UE 404 may engage in communication 420 via the high frequency range associated with the second set of reference signals and/or SSBs 414.

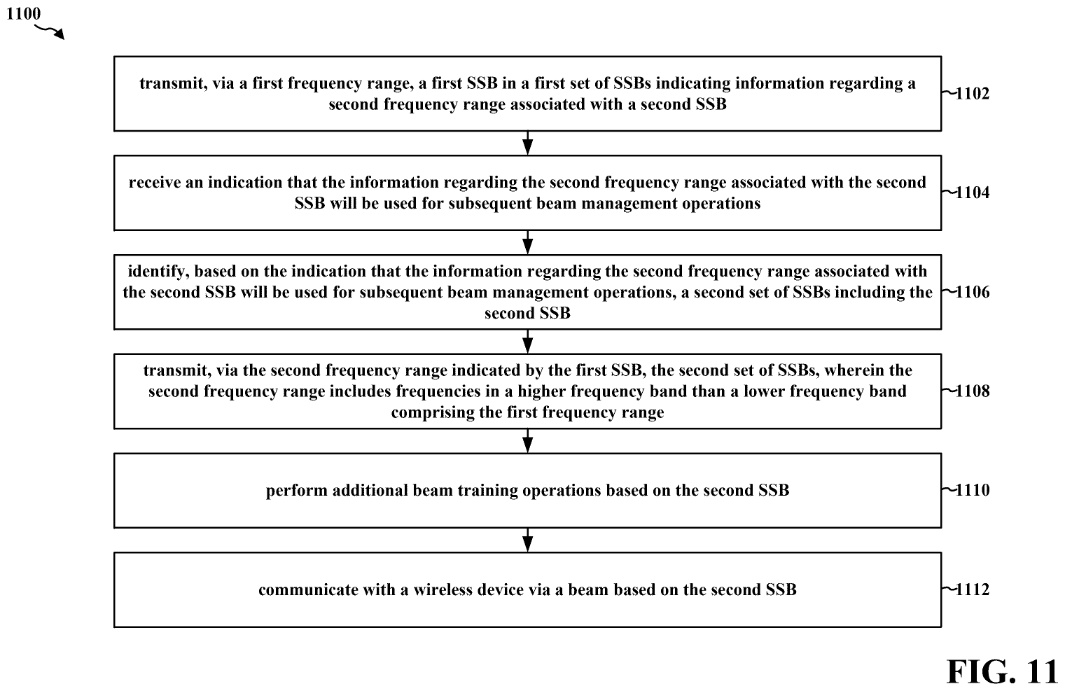

FIG. 11 is a flowchart 1100 of a method of wireless communication. The method may be performed by a network node (e.g., the base station 102, 402, or 502; the CU 110; the DU 130; the RU 140; the network entity 1302). In some aspects, the network node may be a base station or a component of a base station. In some aspects, the network node may be an IAB node or other network node. In some aspects, the method may be performed by a UE, e.g., for sidelink communication. At 1102, the network node may transmit, via a first frequency range, a first SSB indicating information regarding a second frequency range associated with a second SSB. For example, 1102 may be performed by CU processor 1312, DU processor 1332, RU processor 1342, transceiver(s) 1346, antenna(s) 1380, and/or alignment initiation component 199 of FIG. 13. In some aspects, the first SSB may include a cell ID. The cell ID, in some aspects, may be included in a first set of bits in a PSS or a SSS. The PSS or the SSS, in some aspects, may further include the information regarding the second frequency range in a second set of bits. The information regarding the second frequency range, in some aspects, includes QCL information. The QCL information, in some aspects, may indicate a QCL between the first SSB and the second SSB. The first SSB, in some aspects, may indicate timing for a transmission of the second SSB. The timing for the transmission of the second SSB may be indicated based on a time occasion of the transmission of the first SSB and an offset value that is zero or greater than zero. For example, referring to FIGS. 4-7, the base station 402/502 may transmit the first set of reference signals and/or SSBs 406 (e.g., via beams 1-4 521-524) including the high-frequency information 612, 622, or 624 (e.g., information regarding the second frequency range), or indicating, by their placement in the first frequency range, information regarding corresponding SSBs in a second set of SSBs (e.g., SSB 721, SSB 722, SSB 723, SSB 724, SSB 725, SSB 726, and SSB 727) in the second frequency range 720. In aspects with co-located high-frequency and low-frequency antennas (e.g., antennas 505a and/or 505b having high-frequency and low-frequency components with a shared center), the QCL information may be based on knowledge of the co-location of the antennas for the different frequency ranges. Additionally, the timing information may be indicated based on the timing of the SSB in the first frequency range 710 timing offset t0.

In some aspects, the information regarding the second frequency range is included in a PBCH of the first SSB. For example, in some aspects, the information regarding the second frequency range is included in a first MIB in the first SSB. The first MIB, in some aspects, may include pilots for equalization and the information regarding the second frequency range and the information regarding the second frequency range may be encoded in the first MIB with one of Viterbi encoding or polar encoding. For example, referring to FIG. 6, the SSB illustrated in diagram 610 may include high-frequency information 612 in a MIB in a PBCH.

In some aspects, the information regarding the second frequency range is indicated by a known mapping between the first frequency range and the second frequency range. For example, referring to FIG. 7, the placement of an SSB (e.g., SSB 711-717) in the first frequency range 710 may indicate, based on a known mapping, information (e.g., a frequency range and timing) associated with an SSB (e.g., SSB 721-727) in the second frequency range 720.

A wireless device (e.g., UE 404 or 504) may receive the transmitted, first SSB among a set of SSBs transmitted via the first frequency range and measure a signal strength and/or quality of each SSB in the set of SSBs to determine that the first SSB has a highest strength and/or quality. The wireless device may, based on the determination, extract the information regarding the second frequency range associated with a second SSB from the first SSB. The network node may, at 1104, receive an indication that the information regarding the second frequency range associated with the second SSB will be used for subsequent beam management operations. For example, 1104 may be performed by CU processor 1312, DU processor 1332, RU processor 1342, transceiver(s) 1346, antenna(s) 1380, and/or alignment initiation component 199 of FIG. 13. The indication may include a report or other indication that the first SSB is associated with a highest signal strength and/or quality. For example, referring to FIGS. 4 and 5, the base station 402 or 502 may receive, and the UE 404 or 504 may transmit, channel quality report 410 (or other indication) indicating that a particular beam (e.g., beam 3 523) has a highest signal strength and/or quality.

At 1106, the network node may identify, based on the indication received at 1104, a second set of SSBs including the second SSB. For example, 1106 may be performed by CU processor 1312, DU processor 1332, RU processor 1342, and/or alignment initiation component 199 of FIG. 13. The network node may identify the second set of SSBs based on a mapping between the first SSB and the second set of SSBs and/or QCL information indicated in the first SSB. The first SSB may be a SSB associated with a highest signal strength in the first set of SSBs. For example, referring to FIG. 4, the base station 402, at 412, may identify, based on the channel quality report 410 or other indication, the second set of high-frequency reference signals and/or SSBs (e.g., a set of RS and/or SSBs associated with a second set of narrower beams in the second frequency range) at the second, higher frequency range corresponding to the beam associated with the strongest signal strength. Referring to FIG. 5, the base station 502 may, based on a report regarding the measurements indicated in graph 560, determine that the set of second Tx beams, beam set 3 513, is indicated to be used for a second stage of a first phase (illustrated in graph 570) of the beam training operation 550 for the higher frequency range

At 1108, the network node may transmit, via the second frequency range indicated by the first SSB, the second SSB. In some aspects, the second frequency range includes frequencies in a higher frequency band than a lower frequency band including the first frequency range. For example, 1104 may be performed by CU processor 1312, DU processor 1332, RU processor 1342, transceiver(s) 1346, antenna(s) 1380, and/or alignment initiation component 199 of FIG. 13. In some aspects, the first SSB may be transmitted at 1102 via a first antenna and the second SSB may be transmitted at 1108 via a second antenna. The first SSB and the second SSB, in some aspects may be transmitted at 1102 and 1104, respectively, by a same antenna. For example, referring to FIGS. 4-7, the base station 402 or 502 may transmit the second set of reference signals and/or SSBs 414 (e.g., the SSB illustrated in diagram 630 in the second frequency range 650 or one of the SSB 721-727 in the second frequency range 720) via a set of beams (e.g., beams 3a-3d in beam set 3 513).

The transmission of the second SSB, at 1108, may be a first phase (e.g., P1) of a beam training operation associated with the second frequency range. The network node may, at 1110, perform additional beam training (e.g., beam refining) operations based on the second SSB with the wireless device. For example, 1110 may be performed by CU processor 1312, DU processor 1332, RU processor 1342, transceiver(s) 1346, antenna(s) 1380, and/or alignment initiation component 199 of FIG. 13. The additional beam training operations may be performed at 1110 for beam training may be performed to determine one or more beams used for a communication between the network node and the wireless device. For example, referring to FIG. 4, the base station 402 and the UE 404 may exchange additional RSs and/or SSBs as part of additional beam training operations 418.

Finally, at 1112, the network node may communicate with the wireless device via a beam based on the second SSB. For example, 1112 may be performed by CU processor 1312, DU processor 1332, RU processor 1342, transceiver(s) 1346, and/or antenna(s) 1380 of FIG. 13. The communication, in some aspects, may be via the second frequency range. For example, referring to FIG. 4, the base station 402 and the UE 404 may engage in communication 420 via the high frequency range associated with the second set of reference signals and/or SSBs 414.

FIG. 12 is a diagram 1200 illustrating an example of a hardware implementation for an apparatus 1204. In some aspects, the apparatus 1204 may be a UE, a component of a UE, or may implement UE functionality. In some aspects, the apparatus 1204 may be a receiver in a wireless network. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the alignment initiation component 198 is configured to receive, via a first frequency range, a first SSB indicating information regarding a second frequency range associated with a second SSB; receive, via the second frequency range indicated by the first SSB, the second SSB, where the second frequency range includes frequencies in a higher frequency band than a lower frequency band comprising the first frequency range; and communicate with a transmitting device via a beam based on the second SSB. The alignment initiation component 198 may be further configured to perform any of the aspects described in connection with the flowcharts in FIGS. 8 and/or 9, or performed by the UE in the communication in FIG. 4. The alignment initiation component 198 may be within the cellular baseband processor 1224, the application processor 1206, or both the cellular baseband processor 1224 and the application processor 1206. The alignment initiation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving, via a first frequency range, a first SSB indicating information regarding a second frequency range associated with a second SSB; means for receiving, via the second frequency range indicated by the first SSB, the second SSB, wherein the second frequency range includes frequencies in a higher frequency band than a lower frequency band comprising the first frequency range; and means for communicating with a transmitting device via a beam based on the second SSB. The apparatus 1204 may further include means to perform any of the aspects described in connection with the flowcharts in FIGS. 8 and/or 9, or performed by the UE in the communication in FIG. 4. The means may be the alignment initiation component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. In some aspects, the network entity 1302 may be a BS, a component of a BS, or may implement BS functionality. The network entity 1302 may include at least one of a CU 1310, a DU 1330, or an RU 1340. For example, depending on the layer functionality handled by the alignment initiation component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the alignment initiation component 199 is configured to transmit, via a first frequency range, a first SSB indicating information regarding a second frequency range associated with a second SSB; transmit, via the second frequency range indicated by the first SSB, the second SSB, where the second frequency range includes frequencies in a higher frequency band than a lower frequency band comprising the first frequency range; and communicate with a wireless device via a beam based on the second SSB. The alignment initiation component 199 may be further configured to perform any of the aspects described in connection with the flowcharts in FIGS. 10 and/or 11, or performed by the base station in FIG. 4. The alignment initiation component 199 may be within one or more processors of one or more of the CU 1310, DU 1330, and the RU 1340. The alignment initiation component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting, via a first frequency range, a first SSB indicating information regarding a second frequency range associated with a second SSB; means for transmitting, via the second frequency range indicated by the first SSB, the second SSB, wherein the second frequency range includes frequencies in a higher frequency band than a lower frequency band comprising the first frequency range; and means for communicating with a wireless device via a beam based on the second SSB. The network entity may further include means to perform any of the aspects described in connection with the flowcharts in FIGS. 10 and/or 11, or performed by the base station in FIG. 4. The means may be the alignment initiation component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, using high frequencies (e.g., sub-THz frequencies (110-160 GHz), frequencies in FR4, or frequencies in FR5 and above) may introduce challenges in beam management. For example, signal attenuation (e.g., channel path loss) may lead to using a narrower beam for a beam management and/or beam training operation (e.g., a phase 1 (P1) operation) in order for a signal to arrive at a receiving device with sufficient power to detect the signal and distinguish the quality of a first beam (or channel) from a second beam (or channel). Using narrower beams, in some aspects, may be associated with a larger number of candidate beams that require a larger number of reference signal or SSB transmissions to sweep. Accordingly, in some aspects of the disclosure, a method or apparatus is provided to perform beam management (or beam training) using a first wider beam at a lower frequency (e.g., frequencies in FR2) associated with less signal attenuation (e.g., channel path loss). While an example is provided in relation to a sub-THz (high) frequency and a FR2 (low) frequency, it should be understood that the method and apparatus disclosed may be applied to any two frequency ranges that are relatively high- and low-frequency.

For example, a transmitting device (e.g., a base station or UE) attempting to perform a beam training for communication via a second, higher frequency may transmit a first set of reference signals or SSBs via a corresponding first set of beams associated with a first, lower frequency range with a first HPBW that is relatively larger than a HPBW of a similarly beamformed beam associated with the second, higher frequency range. Based on a measured power of the reference signals or SSBs at a receiving device (e.g., a UE), the transmitting device may identify a corresponding second set of beams associated with the second, higher frequency range and transmit a second set of reference signals via the corresponding second set of beams associated with the second, higher frequency range. For example, the second set of beams, in some aspects, may include a set of beams at a highest (e.g., widest) level of a beam hierarchy used for a P1 beam training operation associated with the second, higher frequency range, where additional beam training (e.g., a second phase (P2) and subsequent phases) may be performed based on a beam at the highest level of the beam hierarchy that is identified as being associated with a best channel quality (e.g., a highest RSRP, RSRQ, SNR, SINR or other similar signal power and/or quality metric for reference signals received from a serving cell, base station beam(s), or UE beam(s)). In some aspects, the use of the first set of beams associated with the first, lower frequency range and the second set of beams associated with the second, higher frequency range may be conceived of as a two-step P1 operation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a receiver, including receiving, via a first frequency range, a first SSB indicating information regarding a second frequency range associated with a second SSB; receiving, via the second frequency range indicated by the first SSB, the second SSB, wherein the second frequency range includes frequencies in a higher frequency band than a lower frequency band comprising the first frequency range; and communicating with a transmitting device via a beam based on the second SSB.

Aspect 2 is the method of aspect 1, where the first SSB indicates cell ID information.

Aspect 3 is the method of aspect 2, where the information regarding the second frequency range is included in one of a PSS or a SSS by indicating the cell ID in a first set of bits and the second frequency range in a second set of bits.

Aspect 4 is the method of any of aspects 1 to 3, where the information regarding the second frequency range associated with the second SSB comprises QCL information.

Aspect 5 is the method of aspect 4, where the QCL information indicates that the second SSB is QCL with the first SSB.

Aspect 6 is the method of any of aspects 1 to 5, where the information regarding the second frequency range is included in a PBCH of the first SSB.

Aspect 7 is the method of any of aspects 1 to 6, where the information regarding the second frequency range is included in a first MIB in the first SSB.

Aspect 8 is the method of aspect 7, where the first MIB includes pilots for equalization and the information regarding the second frequency range.

Aspect 9 is the method of any of aspects 7 or 8, where the information regarding the second frequency range is encoded in the first MIB with one of Viterbi encoding or polar encoding.

Aspect 10 is the method of any of aspects 1 to 9, where the information regarding the second frequency range is indicated by a mapping between the first frequency range and the second frequency range.

Aspect 11 is the method of any of aspects 1 to 10, where the first SSB further indicates a timing for a transmission of the second SSB.

Aspect 12 is the method of aspect 11, where the timing for the transmission of the second SSB is indicated by a time occasion of the transmission of the first SSB and an offset value that is zero or greater than zero.

Aspect 13 is a method of wireless communication at a transmitter, including transmitting, via a first frequency range, a first SSB indicating information regarding a second frequency range associated with a second SSB; transmitting, via the second frequency range indicated by the first SSB, the second SSB, wherein the second frequency range includes frequencies in a higher frequency band than a lower frequency band comprising the first frequency range; and communicating with a wireless device via a beam based on the second SSB.

Aspect 14 is the method of aspect 13, where the first SSB indicates cell ID information.

Aspect 15 is the method of aspect 14, where the information regarding the second frequency range is included in one of a PSS or a SSS by indicating the cell ID in a first set of bits and the second frequency range in a second set of bits.

Aspect 16 is the method of any of aspects 13 to 15, where the information regarding the second frequency range associated with the second SSB comprises QCL information.

Aspect 17 is the method of aspect 16, where the QCL information indicates that the second SSB is QCL with the first SSB.

Aspect 18 is the method of any of aspects 13 to 17, where the information regarding the second frequency range is included in a PBCH of the first SSB.

Aspect 19 is the method of any of aspects 13 to 18, where the information regarding the second frequency range is included in a first MIB in the first SSB.

Aspect 20 is the method of aspect 19, where the first MIB includes pilots for equalization and the information regarding the second frequency range.

Aspect 21 is the method of any of aspects 19 or 20, where the information regarding the second frequency range is encoded in the first MIB with one of Viterbi encoding or polar encoding.

Aspect 22 is the method of any of aspects 13 to 21, where the information regarding the second frequency range is indicated by a mapping between the first frequency range and the second frequency range.

Aspect 23 is the method of any of aspects 13 to 22, where the first SSB further indicates a timing for a transmission of the second SSB.

Aspect 24 is the method of aspect 23, where the timing for the transmission of the second SSB is indicated by a time occasion of the transmission of the first SSB and an offset value that is zero or greater than zero.

Aspect 25 is the method of any of aspects 13 to 24, where the first SSB is transmitted via a first antenna and the second SSB is transmitted via a second antenna.

Aspect 26 is an apparatus for wireless communication at a device including a memory and at least one processor coupled to the memory and, based at least in part on information stored in the memory, the at least one processor is configured to implement any of aspects 1 to 12.

Aspect 27 is an apparatus for wireless communication at a device including means for implementing any of aspects 1 to 12.

Aspect 28 is the apparatus of aspect 26 or 27, further including a transceiver or an antenna.

Aspect 29 is a computer-readable medium (e.g., a non-transitory computer-readable medium) storing computer executable code, where the code when executed by a processor causes the processor to implement any of aspects 1 to 12.

Aspect 30 is an apparatus for wireless communication at a device including a memory and at least one processor coupled to the memory and, based at least in part on information stored in the memory, the at least one processor is configured to implement any of aspects 13 to 25.

Aspect 31 is an apparatus for wireless communication at a device including means for implementing any of aspects 13 to 25.

Aspect 32 is the apparatus of aspect 30 or 31, further including a transceiver or an antenna.

Aspect 33 is a computer-readable medium (e.g., a non-transitory computer-readable medium) storing computer executable code, where the code when executed by a processor causes the processor to implement any of aspects 13 to 25.

What is claimed is:

1. An apparatus for wireless communication at a receiving device, comprising:
a memory; and
at least one processor coupled to the memory and, based at least in part on stored information that is stored in the memory, the at least one processor is configured to:
receive, via a first frequency range, a first synchronization signal block (SSB) indicating information regarding a second frequency range associated with a second SSB;
receive, via the second frequency range indicated by the first SSB, the second SSB, wherein the second frequency range includes frequencies in a higher frequency band than a lower frequency band comprising the first frequency range; and
communicate with a transmitting device via a beam based on the second SSB.

2. The apparatus of claim 1, wherein the first SSB indicates cell identifier (ID) information.

3. The apparatus of claim 2, wherein the information regarding the second frequency range is included in one of a primary synchronization signal (PSS) or a secondary synchronization signal (SSS) by indicating the cell ID in a first set of bits and the second frequency range in a second set of bits.

4. The apparatus of claim 1, wherein the information regarding the second frequency range associated with the second SSB comprises quasi-co-location (QCL) information.

5. The apparatus of claim 4, wherein the QCL information indicates that the second SSB is QCL with the first SSB.

6. The apparatus of claim 1, wherein the information regarding the second frequency range is included in a physical broadcast channel (PBCH) of the first SSB.

7. The apparatus of claim 1, wherein the information regarding the second frequency range is included in a first master information block (MIB) in the first SSB.

8. The apparatus of claim 7, wherein the first MIB includes pilots for equalization and the information regarding the second frequency range.

9. The apparatus of claim 7, wherein the information regarding the second frequency range is encoded in the first MIB with one of Viterbi encoding or polar encoding.

10. The apparatus of claim 1, wherein the information regarding the second frequency range is indicated by a mapping between the first frequency range and the second frequency range.

11. The apparatus of claim 1, wherein the first SSB further indicates a timing for a transmission of the second SSB.

12. The apparatus of claim 11, wherein the timing for the transmission of the second SSB is indicated by a time occasion of the transmission of the first SSB and an offset value that is zero or greater than zero.

13. An apparatus for wireless communication at a transmitting device, comprising:
a memory; and
at least one processor coupled to the memory and, based at least in part on stored information that is stored in the memory, the at least one processor is configured to:
transmit, via a first frequency range, a first synchronization signal block (SSB) indicating information regarding a second frequency range associated with a second SSB;
transmit, via the second frequency range indicated by the first SSB, the second SSB, wherein the second frequency range includes frequencies in a higher frequency band than a lower frequency band comprising the first frequency range; and
communicate with a receiving device via a beam based on the second SSB.

14. The apparatus of claim 13, wherein the first SSB indicates cell identifier (ID) information.

15. The apparatus of claim 14, wherein the information regarding the second frequency range is included in one of a primary synchronization signal (PSS) or a secondary synchronization signal (SSS) by indicating the cell ID in a first set of bits and the second frequency range in a second set of bits.

16. The apparatus of claim 13, wherein the information regarding the second frequency range associated with the second SSB comprises quasi-co-location (QCL) information.

17. The apparatus of claim 16, wherein the QCL information indicates that the second SSB is QCL with the first SSB.

18. The apparatus of claim 13, wherein the information regarding the second frequency range is included in a physical broadcast channel (PBCH) of the first SSB.

19. The apparatus of claim 13, wherein the information regarding the second frequency range is included in a first master information block (MIB) in the first SSB.

20. The apparatus of claim 19, wherein the first MIB includes pilots for equalization and the information regarding the second frequency range.

21. The apparatus of claim 19, wherein the information regarding the second frequency range is encoded in the first MIB with one of Viterbi encoding or polar encoding.

22. The apparatus of claim 13, wherein the information regarding the second frequency range is indicated by a known mapping between the first frequency range and the second frequency range.

23. The apparatus of claim 13, wherein the first SSB further indicates timing for a transmission of the second SSB.

24. The apparatus of claim 23, wherein the timing for the transmission of the second SSB is indicated by a time occasion of the transmission of the first SSB and an offset value that is zero or greater than zero.

25. The apparatus of claim 13, wherein the first SSB is transmitted via a first antenna and the second SSB is transmitted via a second antenna.

26. A method for beam management at a receiving device, the method comprising:
receiving, via a first frequency range, a first synchronization signal block (SSB) indicating information regarding a second frequency range associated with a second SSB;
receiving, via the second frequency range indicated by the first SSB, the second SSB, wherein the second frequency range includes frequencies in a higher frequency band than a lower frequency band comprising the first frequency range; and
communicating with a transmitting device via a beam based on the second SSB.

27. The method of claim 26, wherein the first SSB indicates cell identifier (ID) information in a first set of bits and the second frequency range in a second set of bits in one or more of a primary synchronization signal (PSS), a physical broadcast channel (PBCH), a first master information block (MIB), or a secondary synchronization signal (SSS).

28. A method for beam management at a transmitting device, the method comprising:
transmitting, via a first frequency range, a first synchronization signal block (SSB) indicating information regarding a second frequency range associated with a second SSB;
transmitting, via the second frequency range indicated by the first SSB, the second SSB, wherein the second frequency range includes frequencies in a higher frequency band than a lower frequency band comprising the first frequency range; and
communicating with a receiving device via a beam based on the second SSB.

29. The method of claim 28, wherein the information regarding the second frequency range is indicated by a known mapping between the first frequency range and the second frequency range.

30. The method of claim 28, wherein the first SSB is transmitted via a first antenna and the second SSB is transmitted via a second antenna.
